(19) United States
(12) Patent Application Publication
(10) Pub. No.: US 2013/0188608 A1
(43) Pub. Date: Jul. 25, 2013

(54) Network Node And Method For Virtual Soft Handoff Operation

(71) Applicants: Krishna Balachandran, Morganville, NJ (US); Joseph H. Kang, Belle Mead, NJ (US); Kemal M. Karakayali, Highland Park, NJ (US); Kiran M. Rege, Marlboro, NJ (US)

(72) Inventors: Krishna Balachandran, Morganville, NJ (US); Joseph H. Kang, Belle Mead, NJ (US); Kemal M. Karakayali, Highland Park, NJ (US); Kiran M. Rege, Marlboro, NJ (US)

(21) Appl. No.: 13/357,965

(22) Filed: Jan. 25, 2012

(51) Int. Cl. H04W 36/08

(52) U.S. Cl. 370/335

(57) ABSTRACT

Various methods and network nodes (e.g., base stations or base transceiver nodes) are provided to address the need for enhanced uplink performance. In a first method, a virtual soft handoff network node receives (501), from a serving network node, information related to uplink communications of user equipment (UE) served by the serving network node, wherein a soft handoff is not established between the virtual soft handoff network node and the UE. The virtual soft handoff network node receives (502) uplink communications between the UE and the serving network node and processes (503) the uplink communications to determine decoded uplink data from the UE. In a second method, a serving network node sends (401) to a virtual soft handoff network node, information related to uplink communications of user equipment (UE), the UE being served by the serving network node but not in soft handoff with the virtual soft handoff network node.

### FIELD O F THE INVENTION

The present invention relates generally to communications and, in particular, to virtual soft handoff operation in wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Consider wireless network 100 illustrated in FIG. 1. Wireless network 100 comprises macro-cells A and B and small cell C. The coverage areas of the macro cells have been represented by hexagons centered on the corresponding base stations (cells) whereas the coverage area of the small cell has been represented by an appropriately centered circle. For the purpose of this example, we assume all base stations to be equipped with omni-directional antennas; however, it should be clear to anyone familiar with the art that embodiments of the invention can easily be implemented utilizing one or more cells with sectorized antennas.

FIG. 1 also depicts four mobile stations 1, 2, 3 and 4. It is assumed that the primary/serving base stations of mobile stations 1, 2, 3 and 4 are cells A, C, B and B respectively. We further assume that the communications between these mobile stations and their respective primary base stations cannot be supported via soft handoffs. (A mobile station in soft handoff maintains simultaneous communication links with multiple cells so that its uplink transmissions are demodulated/decoded at multiple base stations. As a result, even if one of these decoding attempts succeeds, the corresponding data can be delivered successfully to the intended recipient.) This may happen for a variety of reasons: For instance, the system itself may not permit soft handoffs (e.g., 3GPP LTE); or, even if the system permits soft handoffs, it may choose not to get a specific mobile station into soft handoff for different reasons: For example, if the mobile station is moving at a high speed, the system may choose to keep it connected only to macro cells to avoid the frequent establishment and tearing down of connections that is likely to happen if it is allowed to get into soft handoffs with small cells.

It is easy to see from FIG. 1 that in the absence of soft handoffs, mobile stations 1 and 3 need to transmit at a high power level to enable successful decoding of their signals at their respective primary base stations (A and B, respectively.) Note that if soft handoffs were permitted, mobile station 1 could have been in soft handoff with macro cell A and small cell C, whereas mobile station 3 could have been in soft handoff with macro cell B and small cell C. This would have allowed these mobile stations to transmit at a power level that is adequate for reaching the small cell C, which is much closer to them (in terms of path loss) than their respective primary base stations (namely, macro cells A and B.) The reduced power level employed by these mobile stations would have led to a lowering of the interference level at all of the base stations in their neighborhood, causing mobile stations communicating with these base stations to operate more efficiently and/or at lower transmit power levels. However, if mobile stations 1 and 3 are not permitted to get into soft handoff with the small cell C, they have to transmit at high power levels in order to reach macro cells A and B, their respective primary base stations (which are the only base stations they are connected to.)

When mobile stations 1 and 3 transmit at high power levels to reach their respective primary base stations, they cause significant interference to mobile stations connected to small cell C. Thus, as shown in FIG. 1, mobile station 2, which is communicating with small cell C, needs to employ a high transmit power level in order that its transmissions are successfully decoded at its primary/serving base station, namely small cell C. Normally, this should not pose a serious problem to mobile station 2 since it is likely to have large enough head-room to overcome the high level of interference at the small cell. This is because of two factors: a) Typically the path loss between a small cell and a mobile communicating with it is likely to be small; and b) Typically, relatively few mobile stations get connected to a small cell so that it can employ low-rate transmissions if mobile stations connected to it do not have enough head-room. However, (although not shown in FIG. 1 in order to avoid cluttering) if there are many small cells in the vicinity of the macro cells A and B and mobile stations communicating with these small cells start transmitting at high power levels, the interference at these macro cells will rise to very high levels, causing serious outage and capacity problems at these (macro) cells.

Thus, new solutions and techniques that are able to address one or more of the above issues encountered in such wireless networks would meet a need and advance wireless communications generally.

### BRIEF DESCRIPTION OF THE DRAWINGS

FIG. 1 is a block diagram depiction of a wireless network with a small cell and two macro-cells.

FIG. 2 is a block diagram depicting how transmission resources are typically organized for communications in OFDMA- based systems.

FIG. 3 is a block diagram depiction of an uplink receiver for a 3GPP-LTE-based system.

FIG. 4 is a logic flow diagram of functionality performed by a serving network node in neighbor discovery in accordance with various embodiments of the present invention.

FIG. 5 is a logic flow diagram of functionality performed by a virtual soft handoff network node in accordance with various embodiments of the present invention.

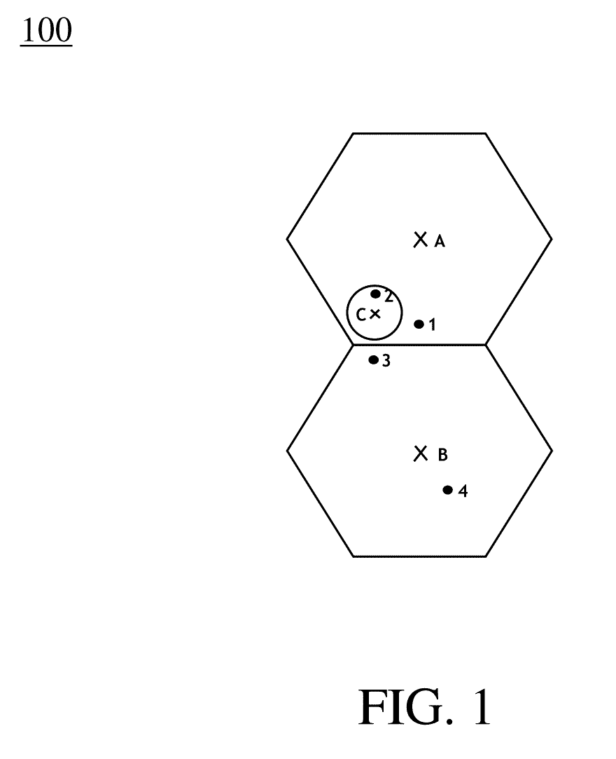

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

Various methods and network nodes (e.g., base stations or cells) are provided to address the need for enhanced uplink performance. In a first method, a virtual soft handoff network node receives, from a serving network node, information related to uplink communications of user equipment (UE) served by the serving network node, wherein a soft handoff is not established between the virtual soft handoff network node and the UE. The virtual soft handoff network node receives uplink communications between the UE and the serving network node and processes the uplink communications to determine decoded uplink data from the UE. An article of manufacture is also provided, the article comprising a processor-readable storage medium storing one or more software programs which when executed by one or more processors performs the steps of this first method.

Many embodiments are provided in which this first method is modified. For example, in some embodiments the virtual soft handoff network node sends, to the serving network node, the decoded uplink data from the UE for the serving network node. In many embodiments, the virtual soft handoff network node cancels the interference caused to uplink communications of a UE served by the virtual soft handoff network node using the decoded uplink data of the UE served by the serving network node and then decodes the uplink communications from the UE served by the virtual soft handoff network node. Additionally or alternatively, in many embodiments, the virtual soft handoff network node decodes uplink communications from a UE served by the virtual soft handoff network node, cancels the interference due to the UE served by the virtual soft handoff network node from the uplink communications of the UE served by the serving network node, and then decodes the uplink communications from the UE served by the serving network node.

In many embodiments, the information related to uplink communications of the UE is received by the virtual soft handoff network node after entering a virtual soft handoff state. In some embodiments, the virtual soft handoff network node determines whether to enter the virtual soft handoff state based on received power measurements made by the virtual soft handoff network node and then indicates to the serving network node that the virtual soft handoff state was being entered. Alternatively, in some embodiments, the virtual soft handoff network node determines whether to initiate virtual soft handoff with the UE based on received signal strength measured at the virtual soft handoff network node and then indicates to the serving network node that the UE is a candidate for virtual soft handoff with the virtual soft handoff network node.

In a second method, a serving network node sends to a virtual soft handoff network node, information related to uplink communications of user equipment (UE), the UE being served by the serving network node but not in soft handoff with the virtual soft handoff network node. An article of manufacture is also provided, the article comprising a processor-readable storage medium storing one or more software programs which when executed by one or more processors performs the steps of this second method.

Many embodiments are provided in which this second method is modified. For example, in many embodiments the serving network node receives from the virtual soft handoff network node decoded uplink data for the serving network node from the UE. In some embodiments, the information related to uplink communications of the UE that the serving network node sends to the virtual soft handoff network node comprises information pertaining to the UE that indicates at least one of transmission grants, allocation/deallocation of a data channel, a modulation and coding scheme to be used, or spreading factors. In some embodiments, the serving network node sends the information related to uplink communications of the UE after receiving an indication that the virtual soft handoff network node was in a virtual soft handoff state. In other embodiments, the serving network node determines, with respect to the UE, whether to initiate virtual soft handoff with the virtual soft handoff network node based on received signal strength reporting from the UE. The serving network node may then indicate to the virtual soft handoff network node that virtual soft handoff with respect to the UE was being initiated.

A network node apparatus is also provided. The network node being configured to communicate with other devices in the system and being operative to receive, from a serving network node, information related to uplink communications of user equipment (UE) served by the serving network node, wherein a soft handoff is not established between the network node and the UE. The network node is also operative to receive uplink communications between the UE and the serving network node and to process the uplink communications to determine decoded uplink data from the UE. Many embodiments are provided in which this network node apparatus is modified. Examples of such embodiments can be found described above with respect to the first method.

A network node apparatus is also provided. The network node being configured to communicate with other devices in the system and being operative to send, to a virtual soft handoff network node, information related to uplink communications of user equipment (UE), the UE being served by the network node but not in soft handoff with the virtual soft handoff network node. Many embodiments are provided in which this node apparatus is modified. Examples of such embodiments can be found described above with respect to the second method.

### DETAILED DESCRIPTION OF EMBODIMENTS

To provide a greater degree of detail in making and using various aspects of the present invention, a description of our approach to enhanced uplink performance and a description of certain, quite specific, embodiments follows for the sake of example. FIGS. 1-3 are referenced in an attempt to illustrate some examples of specific embodiments of virtual soft handoff enabled dominant interference cancellation. Two main embodiments of the present invention are described in detail below.

### Embodiment 1

In this embodiment, virtual soft handoffs are triggered by measurements made by mobile stations. We describe this embodiment using an example of a wireless network employing the Code Division Multiple Access (CDMA) technology, such as those based on the WCDMA or CDMA2000 standards. Note that although we describe this embodiment using a wireless network based on the CDMA technology, the scope of this embodiment need not be limited to such networks.

In this embodiment of the present invention, a base station informs all of its mobile stations (i.e., those for which the base station is the primary/serving base station) of other base stations in its neighborhood. This can be done, for example, by periodically broadcasting a “neighbor list” or by sending to these mobile stations individual messages carrying a neighbor list. In either case, a mobile station is aware of the base stations in its neighborhood besides its primary base station. Each mobile station estimates/measures the received signal strength for its primary base station and each of the base stations in the neighbor list by processing the reference symbol sequences transmitted by these base stations. Furthermore, each mobile station periodically reports these estimated/measured received signal strengths to its primary base station. We refer to these reports as RSSI reports and the reported received signal strengths as RSSI values. We assume that these RSSI values are in decibel over milliwatt (dBm). Note that this reporting can be done in many different ways: For example, a base station may periodically request each of the mobile stations communicating with it to send an RSSI report, and the mobile station may send such a report in response to the request. Alternatively, a mobile station, on its own (i.e., without being requested), may periodically send an RSSI report to its primary base station. A third alternative might involve event-driven reporting where a mobile station sends an RSSI report on the occurrence of certain events, such as when the measured/estimated received signal strength for any base station in the neighbor list crosses a certain threshold.

We now describe the actions performed by a base station when it receives an RSSI report. Referring to the example network depicted in FIG. 1, assume that the neighbor lists transmitted by base stations A, B and C to their respective mobile stations are given by the sets {B, C}, {A, C} and {A, B}, respectively. Now consider the event where base station A receives an RSSI report transmitted by mobile station 1. This report consists of the most recent RSSI values (as measured/estimated by mobile station 1) associated with its primary base station (i.e., base station A) and those included in its neighbor list, namely base stations B and C. We refer to the RSSI values associated with these base stations (and reported by mobile station 1) by r_{A1}, r_{B1}, and r_{C1}, respectively. When base station A receives the RSSI report containing the RSSI values r_{A1}, r_{B1}, and r_{C1}, it does the following: From each of the RSSI values associated with the base stations in its neighbor list (i.e., base stations B and C), it subtracts the RSSI value associated with itself and compares the difference to a threshold value Δᵥₛₕₒ. Thus, it compares the differences “r_{B1}-r_{A1}” and “r_{C1}-r_{A1}” with the threshold value Δᵥₛₕₒ. The threshold value Δᵥₛₕₒ may be fixed or may depend on the type of the base station with which the RSSI is associated (i.e., base stations B or C in the present case) and the type of the base station doing the comparison (i.e., base station A). For instance, note that uplink interference caused by macro cell users to small cells has far more serious consequences than the uplink interference caused by macro cell users to (other) macro cell receivers or by small cell users to macro cell receivers or other small cell receivers. As a consequence, the threshold value for comparing the difference r^{C1}-r_{A1}” may be set significantly lower than that for comparing the difference “r_{B1}-r_{A1}”. For example, the threshold value for comparing “r_{C1}-r_{A1}” could be −15 dB whereas that for comparing “r_{B1}-r_{A1}” could be 0 dB. (This is because a mobile station communicating with base station A, a macro cell, can cause much more serious interference-related problems at the small cell C than at the macro cell B.)

In the scenario where the uplink transmissions from mobile station 1 cause significant interference at the small cell C, the RSSI difference “r_{C1}-r_{A1}” is likely to be greater than the corresponding threshold value Δᵥₛₕₒ. Consequently, the macro cell A sends, over the backhaul (not shown in FIG. 1), a virtual soft handoff message to small cell C, indicating to the latter that it should participate as a secondary cell in a virtual soft handoff involving mobile station 1. The virtual soft handoff contains the following: Macro cell A's own identifier, an identifier of the mobile station 1, a time parameter Tᵥₛₕₒ, which indicates how long the virtual soft handoff should be supported, any additional information that might be needed to decode the uplink transmissions of mobile station 1. The time parameter Tᵥₛₕₒ may be fixed or variable. The additional information includes user-specific information such as spreading codes, uplink channel allocations, etc.

There are some obvious similarities between these actions and those involved in carrying out soft handoffs in networks such as those based on WCDMA or CDMA2000 standards. However, there are some key differences as well: In a soft handoff, the concerned mobile station is explicitly involved—in the signaling as well as the data plane. For example, the mobile station needs to successfully receive and acknowledge the handoff direction message in order for a soft handoff to be established. Also, it needs to be prepared to receive its downlink data and closed-loop power control commands (uplink transmit power control) from all of the base stations involved in the soft handoff. As far as the uplink communications are concerned, being able to receive closed-loop power control command from multiple base stations is the key feature of soft handoff that enables the mobile station to lower its transmit power. In contrast, in the virtual soft handoff scheme being presented here, the mobile station is completely unaware of the virtual soft handoff state, i.e., that multiple base stations are processing its uplink transmissions. It receives its closed-loop power control commands from a single base station—its primary/serving base station.

In this first embodiment of the invention, when small cell C receives the virtual soft handoff message from macro cell A, it sets a timer to expire after a time interval equal to Tᵥₛₕₒ and prepares itself for receiving mobile station 1's uplink transmissions. For example, if the network conforms to the WCDMA or CDMA2000 standard, this preparation would involve allocating a channel element for receiving mobile station 1's uplink transmissions. This channel element typically comprises a RAKE receiver with multiple “fingers,” with one finger designated as a search finger. The search finger processes the signal samples received at small cell C's antenna(s) to identify the multipath components associated with mobile station 1's uplink transmissions. Provided that a multipath component associated with mobile station 1 is strong enough, one of the remaining fingers of the RAKE receiver is assigned for tracking the multipath component and extracting an estimate of the transmitted signal by processing it. Signal estimates thus extracted by RAKE receiver fingers assigned to different multipath components of mobile station 1 are combined before they are fed to a decoding engine. The operation of a RAKE receiver is well known to those familiar with the art.

Besides providing relevant information to small cell C via the virtual soft handoff message, macro cell A also sends to small cell C all of the commands/instructions it sends to mobile station 1 that concern mobile station 1's uplink communications. Thus, for example, any commands sent to mobile station 1 that indicate transmission grants, allocation/deallocation of data channels, changes in the modulation and coding scheme, spreading factors, etc. are also relayed to small cell C. The idea is to ensure that as long as the virtual soft handoff persists, small cell C is aware of and is ready to receive mobile station 1's uplink transmissions just as it would be if it were in a real soft handoff with that mobile station.

Thus, as long as the virtual soft handoff condition persists (i.e., small cell C has received the virtual soft handoff message from macro cell A and the timer it set on the reception of this message has not expired), whenever mobile station 1 transmits packets over its uplink channel(s), small cell C carries out the appropriate processing to decode the transmitted packets. These processing steps include channel estimation (based on reference symbols transmitted by the mobile station), demodulation, de-spreading, de-interleaving and decoding operations.

If the small cell C succeeds in decoding the data transmitted by mobile station 1, it can next perform a key operation. (Successful decoding is typically indicated by the corresponding packet passing a cyclic redundancy check (CRC).) This key operation involves reconstructing the signal transmitted by mobile station 1 as seen at small cell C's receiver, and then subtracting it from the overall received signal to reduce the level of interference in the latter.

In a CDMA-based system such as WCDMA or CDMA2000, signal reconstruction and interference cancellation is performed in the time domain. Thus, in these systems, the aggregate received signal samples are collected at the output of each receive antenna. Next, small cell C's receiver attempts to decode, reconstruct and cancel the signal attributed to mobile station 1 before it attempts to process signals transmitted by its own mobile stations. As we saw earlier, small cell C allocates a RAKE receiver to extract the data transmitted by mobile station 1. Different “fingers” of the RAKE receiver lock on to different multipath components within mobile station 1's signal. Simultaneously, they also produce corresponding channel estimates by processing the reference signals transmitted by mobile station 1. RAKE receiver fingers de-spread the aggregate received signal samples by multiplying them by the appropriate spreading sequences and channelization codes and summing the resulting products. The de-spread signals from different fingers are combined in accordance with the maximal ratio combining (MRC) technique and put through the remaining processing steps (i.e., de-interleaving, demodulation, decoding, etc.) of the receiver chain. If small cell C succeeds in decoding mobile station 1's data, it reconstructs the corresponding received signal and cancels it from the aggregate received signal as described next:

Small cell C re-encodes, re-interleaves and re-modulates mobile station 1's data in accordance with the MCS known to have been used by mobile station 1. It then multiplies the resulting samples by the spreading sequence and channelization code to produce re-spread signal samples. Finally, for each RAKE finger that locked on to a distinct multipath component within mobile station 1's signal, it multiples the re-spread signal samples by the corresponding channel estimate, time-shifts them by an appropriate amount and subtracts them from the aggregate received signal samples collected at the antenna output (and stored) as described earlier. The resulting post-cancellation aggregate received samples are fed to the RAKE receiver(s) allocated to extract signals transmitted by mobile station(s) communicating with small cell C (e.g., mobile station 2 in FIG. 1).The low interference level resulting from interference cancellation allows mobile stations communicating with small cell C (e.g., mobile station 2 in FIG. 1) to transmit their signals at relatively low power levels, which avoids several interference-related problems noted above. Small cell C continues to perform the decoding, reconstruction and cancellation operations on mobile station 1's uplink transmissions as long as the virtual soft handoff persists.

Note that in this embodiment, each mobile station periodically sends its RSSI report to its primary base station and the base station compares the differences in the reported RSSI values with appropriate thresholds to determine if the mobile station needs to enter into a virtual soft handoff with any of the neighboring base stations. If a base station finds that a mobile station communicating with it needs to enter into a virtual soft handoff with a neighboring base station, it sends to the latter a virtual soft handoff message as described above. A base station can simultaneously be in virtual soft handoff (as a secondary base station) for multiple mobile stations. For instance, referring to FIG. 1, small cell C is likely to be in virtual soft handoff with macro cell A for mobile station 2 and with macro cell B for mobile station 3. If a base station is in virtual soft handoff (as a secondary base station) for multiple mobile stations, it attempts to decode the transmissions of all of these mobile stations first. After decoding these transmissions, it reconstructs the corresponding received signals and cancels them out from its aggregate received signal before attempting to decode the transmissions of its own mobile stations using the post-cancellation aggregate received signal samples.

If a base station is involved (as a secondary base station) in a virtual soft handoff for a mobile station communicating with some other base station, it carries out the corresponding decoding, signal reconstruction and cancellation operations as long as the corresponding timer has not expired. If it receives, before the timer expires, another virtual soft handoff message concerning the same mobile station from the latter's primary base station, it refreshes the timer in accordance with the timer value indicated in the message and continues to perform the above operations. If the timer expires, the base station de-allocates any resources it may have assigned to decode the transmissions of the mobile station involved in the virtual soft handoff, and discontinues the decoding/reconstruction/cancellation operations associated with that mobile station.

A further (optional) feature of this approach is described next. Note that a key benefit of this approach is that it allows cells (base stations) to demodulate and decode uplink transmissions from mobile stations for which they are in virtual soft handoff with the corresponding base stations. (For example, small cell C attempts to decode uplink transmissions from mobile station 1 when small cell C is in virtual soft handoff with macro cell A for mobile station 1.) Typically, such scenarios occur when a mobile station is closer (in terms of path loss) to a cell other than the one with which it is attempting to communicate. (For example, as in the example of FIG. 1, mobile station 1 is closer to small cell C than it is to macro cell A.) It is easy to see that in such scenarios, the cell which participates in the virtual soft handoff as a secondary base station (e.g., small cell C in the example of FIG. 1) is likely to be in a better position to decode the mobile station's uplink communications than the cell with which the mobile station is attempting to communicate. As a consequence, in accordance with this optional feature being described here, if the cell participating in the virtual soft handoff as a secondary base station succeeds in decoding the data transmitted by the mobile station, it forwards it over the backhaul links to the cell with which the mobile station is communicating (i.e., its primary base station). Thus, in the example of FIG. 1, if small cell C succeeds in decoding a data packet transmitted by mobile station 1, it forwards that data packet over the backhaul links to macro cell A. This increases the likelihood of macro cell A (the intended recipient of mobile station 1′ uplink transmissions) successfully receiving the uplink data transmitted by mobile station 1. The increase in the likelihood of successful delivery of uplink communications enables mobile stations to employ even lower levels of transmit power, leading to improvement of the network's spectral efficiency and edge throughputs.

Note that in order to implement the approach described with respect to embodiment 1, the mobile stations do not have to do anything other than reporting RSSI values. This is a feature supported by mobile stations conforming to most of the existing and emerging wireless network standards. The concept of virtual soft handoff and the corresponding base station actions can be looked upon as a form of base station cooperation. It is evident that this cooperation involves the exchange of only a small amount of data (e.g., virtual soft handoff messages, sending the information related transmission grants, etc.) between base stations. However, the potential payoff in terms of the gains in uplink spectral efficiency and edge throughput will be significant in heterogeneous networks.

### Embodiment 2

In this embodiment, virtual soft handoffs are triggered by measurements made by base stations. We describe this embodiment using an example of a wireless network employing an Orthogonal Frequency Division Multiple Access (OFDMA) scheme, e.g., 3GPP LTE. Once again, even though we describe this embodiment using an example of an OFDMA-based wireless network, the scope of this embodiment need not be limited to such networks.

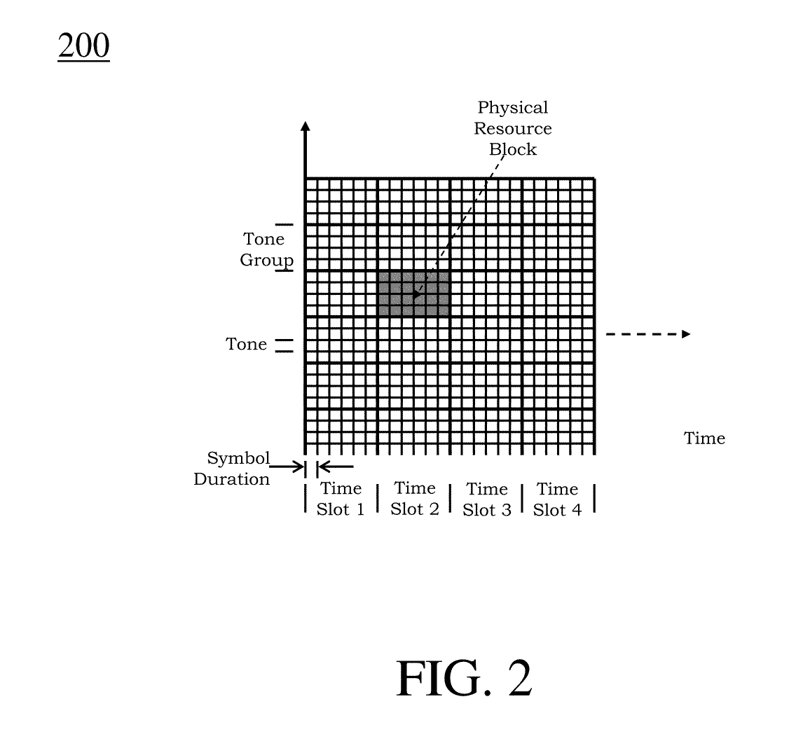

In an OFDMA-based wireless network, the spectrum available for uplink transmissions is divided into multiple sub-carriers or tones. FIG. 2 illustrates how transmission resources are typically organized for uplink (or downlink) communications in OFDMA-based networks. As depicted in diagram 200, time is divided into slots, each time slot comprising N_{S} symbol durations. Along the frequency dimension, the available spectrum comprises N_{T} tones or sub-carriers. These N_{T} tones are divided into N_{R} groups, each comprising M (=N_{T}/N_{R}) tones. A Physical Resource Block (PRB) consists of M tones belonging to a group repeated over the N_{S} symbol durations in a time slot. Thus, a resource block comprises M×N_{S} modulation symbols. The basic unit for transmission resource allocation is a resource block. It is easy to see that there are N_{R} resource blocks associated with a time slot.

In the present embodiment, during every time slot, each base station measures the received power (signal strength) over each PRB, and counts the number of PRBs for which the measured received power exceeds a certain threshold value T_{H}. Let N(k) denote the number of PRBs for which the measured received power exceeded the threshold T_{H} during time slot k. Using a sliding window of length W time slots, the base station keeps track of the number of PRBs over the preceding W time slots for which the received power as measured by the base station exceeded the threshold T_{H}. In other words, if the current slot index is n, the base station uses the following formula to compute M(n), the number of PRBs over the preceding W time slots for which the received power as measured by the base station exceeded the threshold T_{H}:

$$M ( n ) = {\sum }_{j = 0}^{W - 1} N ( n - j ) .$$

Each base station is aware of other base stations in its neighborhood. Whenever a base station finds that M(n) exceeds another threshold value, say, Mₘₐₓ, it sends a virtual soft handoff message to all base stations in its neighborhood. Thus, for instance, if the small cell C finds that the number of PRB's over the preceding W time slots for which the received uplink power is greater than the threshold value Mₘₐₓ, it sends a virtual soft handoff message to all base stations in its neighborhood, i.e., to macro cell A and macro cell B. As in the previous embodiment, the virtual soft handoff message includes a timer value Tᵥₛₕₒ; however, unlike in the previous embodiment, the virtual soft handoff message does not include the identity of any mobile device. Small cell C also sets a timer to expire after a time interval T_{refresh}, where T_{refresh}<Tᵥₛₕₒ. When the timer T_{refresh} actually expires, if the latest value of M(n) exceeds the threshold value Mₘₐₓ, small cell C sends another virtual soft handoff message to the base stations in its neighborhood. If M(n) does not exceed Mₘₐₓ, it signals the end of the virtual soft handoff condition as far as small cell C is concerned.

We now describe the actions carried out by a base station when it receives a virtual soft handoff message. To that end, we consider macro cell B's actions after it receives the virtual soft handoff message sent by small cell C. The virtual soft handoff message indicates to macro cell B that small cell C wishes to participate, as a secondary base station, in a virtual soft handoff with macro cell B. Thus, when macro cell B receives the virtual soft handoff message from small cell C, it sets a timer to expire after Tᵥₛₕₒ time units as indicated by the corresponding parameter in the message and enters, as a primary base station, a state of virtual soft handoff with small cell C. If macro cell B receives another virtual soft handoff message from small cell C before the timer expires, it refreshes the timer and continues to be in virtual soft handoff with small cell C. If the timer expires, it discontinues the state of virtual soft handoff.

There is a significant difference between the state of virtual soft handoff in the previous embodiment and the present one: In the previous embodiment, the state of virtual soft handoff between multiple base stations concerned a specific mobile station (e.g., we saw that small cell C and macro cell A were in a virtual soft handoff to process the uplink transmissions of mobile station 1). In contrast, the state of virtual soft handoff in the present embodiment is a general one. That is, when macro cell B receives a virtual soft handoff message sent by small cell C, the former enters a virtual soft handoff with small cell C for all mobile stations for which macro cell B is the primary base station. In other words, small cell C will be in virtual soft handoff with macro cell B for mobile stations 3 and 4. When macro cell B receives this message, it sets a timer to expire after Tᵥₛₕₒ time units, and as long as this timer has not expired it assumes to be in virtual soft handoff with small cell C. In this state, whenever it schedules an uplink transmission (by mobile stations 3 or 4) or sends a control message to regulate uplink transmissions, it sends a copy of these scheduling grants/messages to small cell C along with any information required for decoding the corresponding transmissions (e.g., information about reference symbol sequences, the modulation and coding scheme being used, etc.). (These copies should be sent a little before the time slot during which the corresponding uplink transmissions are scheduled to take place so that they reach small cell C before the beginning of that time slot.) As a result, as long as this state of virtual soft handoff persists, small cell C is ready to process (i.e., demodulate/decode) uplink transmissions by mobile stations communicating with macro cell B.

Let us now consider the actions of small cell C after it receives (from macro cell B) the copies of scheduling grants/control messages corresponding to uplink transmissions over a certain time slot. Then, in accordance with the present embodiment, at the end of the time slot, small cell C first carries out processing required to decode the uplink transmissions of mobile stations communicating with macro cell B. Note that small cell C may attempt to decode the uplink transmissions of a mobile station communicating with macro cell B only if it uses a PRB also used by a mobile station communicating with small cell C. The first step in decoding the uplink transmissions of a mobile station communicating with macro cell B is to obtain the corresponding channel estimates. Using the reference symbol sequences used by the mobile station (which are embedded in the corresponding PRB's), small cell C obtains channel estimates associated with that mobile station. If these channel estimates are too weak (i.e., the corresponding power level is less than some threshold value), small cell C does not attempt to decode the uplink transmissions of that mobile station. Otherwise, it proceeds with the decoding process to extract the signals transmitted by that mobile station. Thus, in the present example, small cell C may find that the channel estimates associated with mobile station 4 are too weak whereas those associated with mobile station 3 are strong. In that case, small cell C may decide not to decode the uplink transmissions associated with mobile station 4 while it proceeds to decode those associated with mobile station 3. If small cell C succeeds in decoding the uplink transmission from a mobile station 3, it attempts to reconstruct the interfering signal associated with the decoded transmission and cancel it from the overall received signal.

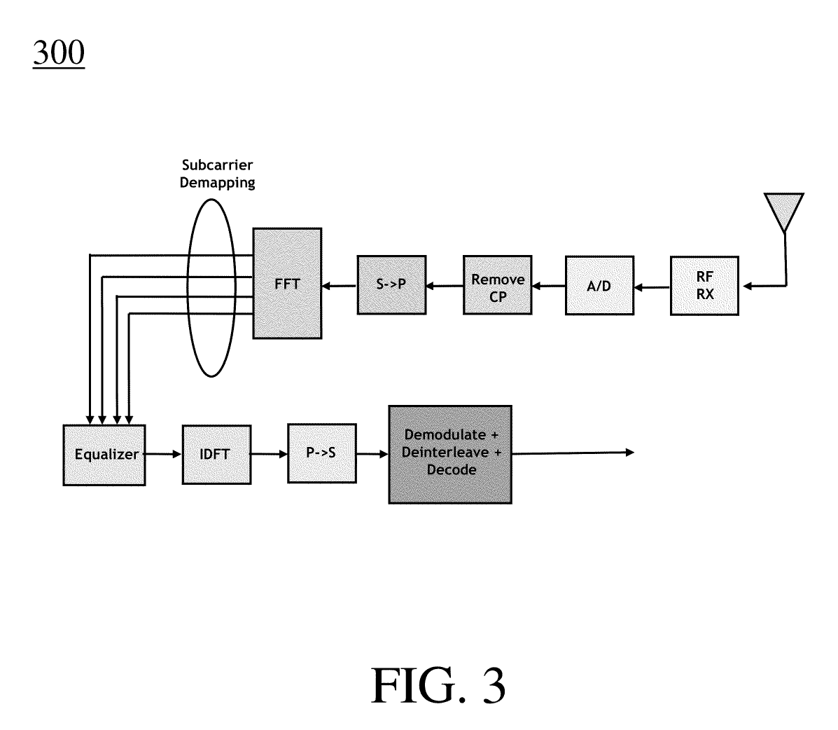

In OFDMA-based systems such as 3GPP LTE, signal reconstruction and interference cancellation is performed in the frequency domain, i.e., on received signal /samples at the end of the FFT operation in the receiver chain. (See diagram 300 of FIG. 3.) Thus, in accordance with the present embodiment, the signal received over each receive antenna undergoes all processing steps up to (and including) the FFT. For each PRB over which small cell C is expecting to receive transmissions from its own mobile stations, it collects and stores signal samples at the output of the FFT for possible interference cancellation. We refer to these signal samples as aggregate received signal samples. Note that the data transmitted by mobile station 3 is also decoded by processing such aggregate received signal samples. On PRB's where mobile station 3 is known to have transmitted its signals, small cell C's receiver processes the aggregate received signal samples to extract the data transmitted by mobile station 3 before attempting to decode the transmissions of its own mobiles (namely mobile station 2).

If small cell C succeeds in decoding the data transmitted by mobile station 3, it attempts interference cancellation using the decoded data. In order to perform interference cancellation, the receiver first reconstructs the signal (transmitted by mobile station 3) as it would appear at the output of the FFT. To that end, it re-encodes, re-interleaves and re-modulates the data using the MCS scheme used by mobile station 3 (which is known to small cell C as described above), performs the DFT operation (as required for the 3GPP LTE uplink), and maps the DFT outputs to appropriate sub-carriers before multiplying these outputs by the corresponding channel estimates. This is small cell C's estimate of the signal samples received from mobile station 3. Next, small cell C subtracts this estimate from the aggregate received signal samples to obtain what we refer to as post-cancellation received signal samples. These post-cancellation received signal samples are processed via the remaining processing steps (e.g., MMSE/MRC signal processing, de-modulation, de-interleaving, and decoding) to extract the signals transmitted by small cell C's own mobiles (e.g., mobile station 2 in FIG. 1.) Note that the interference caused by mobile station 3 constitutes a significantly large part of the overall noise and interference experienced by small cell C. Consequently, after this interference is cancelled out as just described, the resulting signal samples become easily decodable even if small cell C's own mobile stations (e.g., mobile station 2 in FIG. 1) use a relatively low transmit level.

Note that the key feature that distinguishes this embodiment from the previous one is that the state of virtual soft handoff in this embodiment is triggered by uplink RSSI measurements carried out by the base station receiver whereas the previous embodiment involved downlink RSSI measurements made by mobile stations (and reported to base stations). Also, in the present embodiment, the state of virtual soft handoff between two base stations is a general one, i.e., it involves all mobile stations communicating with one of the base stations. In the previous embodiment, the state of virtual soft handoff between a pair of base stations involved specific mobile stations communicating with one of the base stations. Finally, the third major difference between the two embodiments is that in the present embodiment the base station that participates in the virtual soft handoff as a secondary base station (i.e., the one that experiences significant uplink interference) originates the virtual soft handoff message whereas in the previous embodiment the virtual soft handoff message was originated by the base station that participated in the virtual soft handoff as the primary base station (i.e., one whose mobile stations were causing significant uplink interference to neighboring base stations).

Although this embodiment was presented using an example of a wireless network based on the OFDMA multiple access technique, it is easy to see that it can be used in wireless networks based on other techniques as well. Thus, its scope is not limited to wireless networks based on OFDMA.

Finally, we note that if base stations within a neighborhood were to exchange uplink scheduling/transmission information for a subset of users (e.g., users with low SINR who may be handoff candidates), neighboring base stations that receive this information could take measurements for these out-of-sector transmissions and report them to the serving base station which would then use the difference metric used in the first embodiment. Alternatively, if the scheduling/transmission information for a set of out-of-sector users is provided along with the serving sector RSSI, the neighboring base station could directly compute the measurement difference, compare the difference to a threshold, and if the threshold is exceeded, attempt decoding. As a final alternative, decoding by neighboring base stations may always be attempted for those out-of-sector users whose scheduling/transmission information has been provided. In any case, if the decoding of out-of-sector users is successful, the decoded data could be sent over the backhaul, perhaps only after confirming that the serving eNB has not been able to decode the data on its own. This would avoid wasting capacity of the backhaul links. Thus, in each of these three cases, virtual soft handoff (VSHO) is based on measurements taken at serving and/or neighboring base stations (as opposed to UEs as in the first embodiment) and is triggered on a per UE basis (and not for all UEs served by an eNB as described in the second embodiment).

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

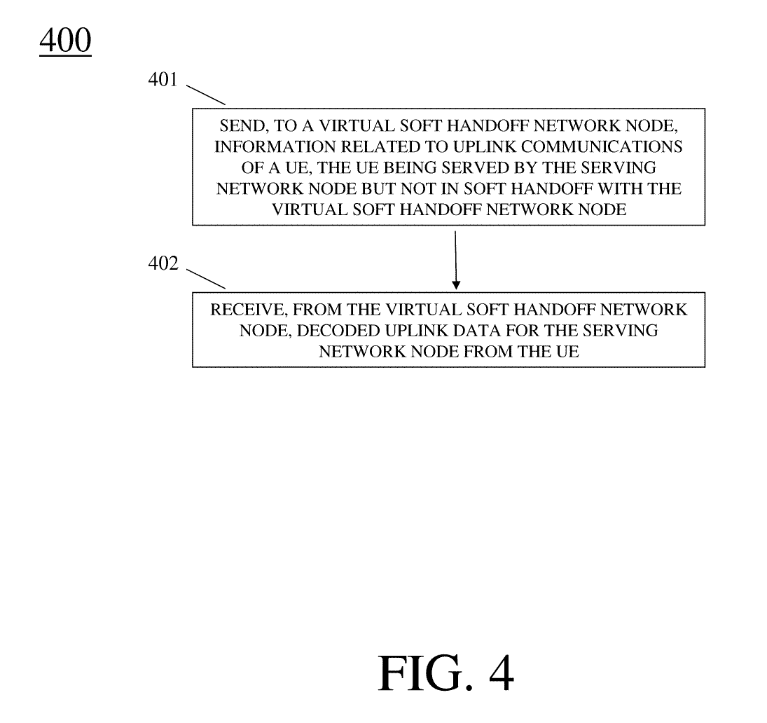

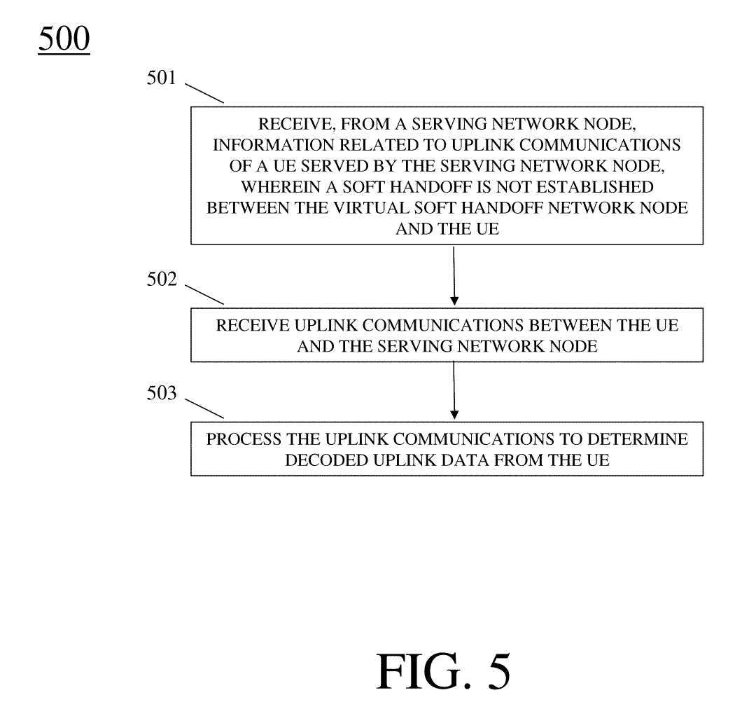

Aspects of embodiments of the present invention can be understood with reference to FIGS. 4 and 5. Diagram 400 of FIG. 4 is a logic flow diagram of functionality performed by a serving network node, while diagram 500 of FIG. 5 is a logic flow diagram of functionality performed by a virtual soft handoff network node. In the method depicted in diagram 400, a serving network node (such as a base station or base transceiver node) sends (401) to a virtual soft handoff network node (such as a base station or base transceiver node), information related to uplink communications of user equipment (UE), the UE being served by the serving network node but not in soft handoff with the virtual soft handoff network node. In the method depicted in diagram 500, the virtual soft handoff network node receives (501), from the serving network node, the information related to uplink communications of the UE served by the serving network node. Again a soft handoff is not established between the virtual soft handoff network node and the UE.

The virtual soft handoff network node receives (502) uplink communications between the UE and the serving network node and processes (503) the uplink communications to determine decoded uplink data from the UE. In some embodiments the virtual soft handoff network node sends, to the serving network node, the decoded uplink data from the UE for the serving network node and the serving network node receives (402) this decoded uplink data. This decoded uplink data can, of course, be beneficial to the serving network node in the case where the serving network node was unable to decode this data from the UE itself.

In many embodiments, to determine the decoded uplink data, the virtual soft handoff network node decodes uplink communications from a UE served by the virtual soft handoff network node, cancels the interference due to the UE served by the virtual soft handoff network node from the uplink communications of the UE served by the serving network node, and then decodes the uplink communications from the UE served by the serving network node. In many embodiments, the virtual soft handoff network node may also cancel the interference caused to uplink communications of a UE served by the virtual soft handoff network node using the decoded uplink data of the UE served by the serving network node and then decode the uplink communications from the UE served by the virtual soft handoff network node.

In many embodiments, the information related to uplink communications of the UE is received by the virtual soft handoff network node after entering a virtual soft handoff state. In some embodiments, the virtual soft handoff network node determines whether to enter the virtual soft handoff state based on received power measurements made by the virtual soft handoff network node and then indicates to the serving network node that the virtual soft handoff state was being entered. Alternatively, in some embodiments, the virtual soft handoff network node determines whether to initiate virtual soft handoff with the UE based on received signal strength measured at the virtual soft handoff network node and then indicates to the serving network node that the UE is a candidate for virtual soft handoff with the virtual soft handoff network node.

In some embodiments, with respect to the serving network node, the information related to uplink communications of the UE that the serving network node sends to the virtual soft handoff network node comprises information pertaining to the

UE that indicates at least one of transmission grants, allocation/deallocation of a data channel, a modulation and coding scheme to be used, or spreading factors. In some embodiments, the serving network node sends the information related to uplink communications of the UE after receiving an indication that the virtual soft handoff network node was in a virtual soft handoff state. In other embodiments, the serving network node determines, with respect to the UE, whether to initiate virtual soft handoff with the virtual soft handoff network node based on received signal strength reporting from the UE. The serving network node may then indicate to the virtual soft handoff network node that virtual soft handoff with respect to the UE was being initiated.

A person of skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of methods described herein. The program storage devices may be, e.g., digital memories, magnetic storage media such as a magnetic disks or tapes, hard drives, or optically readable digital data storage media. The embodiments are also intended to cover computers programmed to perform said steps of methods described herein.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method comprising:
receiving, by a virtual soft handoff network node from a serving network node, information related to uplink communications of user equipment (UE) served by the serving network node, wherein a soft handoff is not established between the virtual soft handoff network node and the UE;
receiving, at the virtual soft handoff network node, uplink communications between the UE and the serving network node;
processing, at the virtual soft handoff node, the uplink communications to determine decoded uplink data from the UE.

2. The method as recited in claim 1, further comprising:
sending, by the virtual soft handoff network node to the serving network node, the decoded uplink data from the UE for the serving network node.

3. The method as recited in claim 1, further comprising:
cancelling the interference caused to uplink communications of a UE served by the virtual soft handoff network node using the decoded uplink data of the UE served by the serving network node;
decoding, at the virtual soft handoff network node, the uplink communications from the UE served by the virtual soft handoff network node.

4. The method as recited in claim 1, wherein processing the uplink communications comprises:
decoding at the virtual soft handoff network node, uplink communications from a UE served by the virtual soft handoff network node;
cancelling the interference due to the UE served by the virtual soft handoff network node from the uplink communications of the UE served by the serving network node;
decoding the uplink communications from the UE served by the serving network node.

5. The method as recited in claim 1, wherein receiving the information related to uplink communications of the UE comprises
receiving the information related to uplink communications of the UE after entering a virtual soft handoff state.

6. The method as recited in claim 5, further comprising:
determining by the virtual soft handoff network node whether to enter the virtual soft handoff state based on received power measurements made by the virtual soft handoff network node;
indicating, by the virtual soft handoff network node to the serving network node, that the virtual soft handoff state was being entered.

7. The method as recited in claim 1, further comprising:
determining by the virtual soft handoff network node whether to initiate virtual soft handoff with the UE based on received signal strength measured at the virtual soft handoff network node;
indicating, by the virtual soft handoff network node to the serving network node, that the UE is a candidate for virtual soft handoff with the virtual soft handoff network node.

8. An article of manufacture comprising a processor-readable storage medium storing one or more software programs which when executed by one or more processors performs the steps of the method of claim 1.

9. A method comprising:
sending, by a serving network node to a virtual soft handoff network node, information related to uplink communications of user equipment (UE), the UE being served by the serving network node but not in soft handoff with the virtual soft handoff network node.

10. The method as recited in claim 9, wherein sending the information related to uplink communications of the UE comprises
sending to the virtual soft handoff network node information pertaining to the UE that indicates at least one of transmission grants, allocation/deallocation of a data channel, a modulation and coding scheme to be used, or spreading factors.

11. The method as recited in claim 9, wherein sending the information related to uplink communications of the UE comprises
sending the information related to uplink communications of the UE after receiving an indication that the virtual soft handoff network node was in a virtual soft handoff state.

12. The method as recited in claim 9, further comprising:
determining by the serving network node with respect to the UE whether to initiate virtual soft handoff with the virtual soft handoff network node based on received signal strength reporting from the UE.

13. The method as recited in claim 12, further comprising:
indicating, by the serving network node to the virtual soft handoff network node, that virtual soft handoff with respect to the UE was being initiated.

14. An article of manufacture comprising a processor-readable storage medium storing one or more software programs which when executed by one or more processors performs the steps of the method of claim 9.

15. A network node of a communication system, the network node being configured to communicate with other devices in the system, wherein the network node is operative
to receive, from a serving network node, information related to uplink communications of user equipment (UE) served by the serving network node, wherein a soft handoff is not established between the network node and the UE,
to receive uplink communications between the UE and the serving network node, and
to process the uplink communications to determine decoded uplink data from the UE.

16. The network node as recited in claim 15, wherein the network node is further operative
to send, to the serving network node, the decoded uplink data from the UE for the serving network node.

17. The network node as recited in claim 15, wherein the network node is further operative
to cancel the interference caused to uplink communications of a UE served by the network node using the decoded uplink data of the UE served by the serving network node and
to decode uplink communications from the UE served by the network node.

18. The network node as recited in claim 15, wherein the network node is further operative
to decode uplink communications from a UE served by the network node;
to cancel the interference due to the UE served by the network node from the uplink communications of the UE served by the serving network node;
to decode the uplink communications from the UE served by the serving network node.

19. The network node as recited in claim 15, wherein the network node is further operative
to determine with respect to the UE whether to initiate virtual soft handoff based on received signal strength measured at the network node;
to indicate, to the serving network node, that the UE is a candidate for virtual soft handoff with the network node.

20. A network node of a communication system, the network node being configured to communicate with other devices in the system, wherein the network node is operative
to send, to a virtual soft handoff network node, information related to uplink communications of user equipment (UE), the UE being served by the network node but not in soft handoff with the virtual soft handoff network node.

21. The network node as recited in claim 20, wherein being operative to send the information related to uplink communications of the UE comprises being operative
to send the information related to uplink communications of the UE after receiving an indication that the virtual soft handoff network node was in a virtual soft handoff state.

22. The network node as recited in claim 20, wherein the network node is further operative
to determine with respect to the UE whether to initiate virtual soft handoff with the virtual soft handoff network node based on received signal strength reporting from the UE and
to indicate, to the virtual soft handoff network node, that virtual soft handoff with respect to the UE was being initiated.
